(19) United States
(12) Patent Application Publication
(10) Pub. No.: US 2006/0078152 A1
(43) Pub. Date: Apr. 13, 2006

(54) Ribbon microphone incorporating a special-purpose transformer and/or other transducer-output circuitry

(76) Inventors: David E. Royer, Fullerton, CA (US); Richard T. Perrotta, Burbank, CA (US)

Correspondence Address: Mitchell, Silberberg & Knupp, LLP, 11377 West Olympic Boulevard, Los Angeles, CA, 90064, US

(21) Appl. No.: 10/961,855

(22) Filed: Oct. 8, 2004

(51) Int. Cl. H04R 1/02; H01F 27/28; H04R 9/06

(52) U.S. Cl. 381/399; 381/386; 381/396; 381/176

(57) ABSTRACT

Provided is a ribbon-microphone circuit that includes a ribbon transducer and a specially designed transformer. In various possible configurations, the transformer: is a toroidal transformer, has multiple interleaved primary windings, has exactly four primary coils, is a tape-wound-core transformer, has a turns ratio of the composite secondary coil to the composite primary coil of at least 100:1, includes at least three interleaved secondary coils, includes at least three interleaved primary coils, and/or has multiple primary and secondary windings that are interleaved with each other. A buffer circuit also may be enclosed within the outer casing.

### BACKGROUND OF THE INVENTION

1. Field of the Invention

The present invention pertains to the improvement of a particular type of microphone, called a ribbon microphone, and specifically is applicable to the incorporation of certain types of transducer-output circuitry into a ribbon microphone.

2. Description of the Related Art

FIG. 1 illustrates a common conventional ribbon microphone 10. Such a microphone typically would be approximately 8 inches high, 4 inches wide and 3 inches deep, and would weigh approximately 7.5 pounds.

The transducer for ribbon microphone 10 is shown in FIG. 2. In its simplest form, a ribbon microphone, such as microphone 10, uses a ribbon 12 (e.g., a very thin piece of corrugated aluminum foil) suspended in a magnetic field. When the ribbon 12 is caused to vibrate by an acoustic (or sound) pressure wave, a voltage is induced along the length of ribbon 12 that ideally is proportional to the frequency and intensity of the sound wave striking it. The use of opposing U-shaped magnets 14 and 15, connected by “pole pieces” 17 and 18 to concentrate the magnetic field produced by magnets 14 and 15 was common in conventional ribbon microphones, such as microphone 10.

More specifically, a ribbon microphone operates on the principle that sound waves will displace an extremely thin ribbon of aluminum foil 12, which is suspended between the poles of a powerful magnet. As the ribbon 12 is displaced, a voltage is induced along its length that is proportional to the velocity of its movement. Normally, a single large magnet, or a pair of magnets 14 and 15, is coupled to a set of pole pieces 17 and 18 that provide the magnetic flux energy to the ribbon element 12. These pole pieces 17 and 18 create the north and south lines of flux that, in large part, are parallel with respect to the generating element (i.e., ribbon 12). The magnets 14 and 15 usually are comprised of cobalt steel, Alnico or ceramic alloys. The pole pieces 17 and 18 usually are made from iron, and are tapered or spidery

Ribbon microphones were first developed commercially in the early 1930s, and they were the mainstay of radio broadcasting and sound recording from the time of their introduction until around the mid 1960s. By this time, ribbon microphones were being supplanted by dynamic moving-coil and capacitor (condenser) microphones, which by then had been improved to the point where they could compete with a ribbon microphone in terms of performance (especially sensitivity and signal-to-noise ratio), size, reliability and cost.

More specifically, refined condenser and dynamic microphones gained popularity steadily in the 1950s and 1960s. Their small size and high-frequency characteristics complemented AM radio broadcast, television, and phonograph recordings very well. It should be noted that one of the most desirable characteristics of these newer microphones was their ability to compensate for the relatively poor high-frequency response of the various technologies of the day and, in the case of capacitor microphones, their output signal level was considerably higher than that of any ribbon microphone. Condenser microphones have a natural tendency to “ring” harmonically in the upper frequency registers due to resonant modes of the diaphragm, which produces the effect of exaggerating the high-frequency response of the microphone. In a way, this made up for generational losses in analog tape mediums, as well as deficiencies in radio and TV broadcasting systems. This same characteristic (actually a form of distortion) would prove to be a great disadvantage with the new digital technology that was to come. However, the small size and durability of condenser microphones furthered their acceptance. It is therefore easy to understand why the ribbon microphone eventually fell out of favor.

By the late 1950s, ribbon microphone manufacturers and their designers determined that the technology had reached its maximum potential and, accordingly, further development mostly was considered unnecessary. With no further development goals and other types of microphones taking over, interest in ribbon-microphone technology waned. The 1960s ushered in the ribbon microphone's passing into obscurity.

Despite the apparent disadvantages of ribbon microphones as compared with the competing technologies, the present inventors have recognized that ribbon microphones also have certain advantages over such technologies. For example, ribbon microphones typically are capable of better reproduction of high frequencies than condenser or moving-coil dynamic microphones, which feature is particularly important in the newer digital recording techniques. Recognizing the potential of ribbon microphones, the present inventors set about improving the ribbon microphone in order to eliminate the conventional disadvantages that are described above.

Certain results of these efforts are described and claimed in U.S. Pat. No. 6,434,252 (the '252 patent) to the present inventors, which patent is incorporated by reference herein as though set forth herein in full. Among other improvements disclosed in the '252 patent are the use of an offset ribbon, improved magnetic material and a magnetic field having uniform perpendicular flux within the air gap.

### SUMMARY OF THE INVENTION

Despite the significant improvements disclosed in the '252 patent, the present inventors have continued to improve ribbon-microphone technology, resulting in the present invention. Generally speaking, the present invention uses a specially designed transformer and/or other specially designed transducer output circuitry in order to provide the ribbon microphone with good sensitivity and frequency response, while simultaneously keeping the microphone small.

Thus, in one aspect the invention is directed to a ribbon-microphone circuit that includes a magnet structure forming an elongated central gap such that an overall magnetic north pole is provided on a first side of the elongated central gap and an overall magnetic south pole is provided on a second side of the elongated central gap. A thin strip of electrically conductive material, referred to as a ribbon, is suspended within the elongated central gap, and an electrical contact is provided at each end of the ribbon for outputting a signal generated by the ribbon. A provided step-up toroidal transformer has plural primary coils electrically coupled to the electrical contacts of the ribbon and also has at least one secondary coil.

By utilizing a toroidal transformer having multiple primary windings, the present invention often can achieve very good frequency response, while simultaneously efficiently utilizing the output of a ribbon transducer.

In another aspect, the invention is directed to a ribbon-microphone circuit that includes a magnet structure forming an elongated central gap such that an overall magnetic north pole is provided on a first side of the elongated central gap and an overall magnetic south pole is provided on a second side of the elongated central gap. A thin strip of electrically conductive material, referred to as a ribbon, is suspended within the elongated central gap, and an electrical contact at each end of the ribbon outputs a signal generated by the ribbon. A provided step-up transformer has plural interleaved primary coils electrically coupled to the electrical contacts of the ribbon and has at least one secondary coil.

By utilizing a transformer having multiple interleaved primary windings, the present invention often can achieve very good frequency response, while simultaneously efficiently utilizing the output of a ribbon transducer.

In more particular aspects of the invention, the transformer is a toroidal transformer, has exactly four primary coils, is a tape-wound-core transformer, has a turns ratio of the at least one secondary coil to the plural primary coils of at least 100:1, has a turns ratio of the at least one secondary coil to the plural primary coils of at least 200:1, includes at least three interleaved secondary coils, and/or includes at least three interleaved primary coils. Preferably, the primary and secondary windings also are interleaved with each other. In other particularized aspects, a buffer circuit is also enclosed within the outer casing and is electrically coupled to the at least one secondary coil, the buffer circuit has an input impedance of at least 10 Megohms, and/or the buffer circuit has an input stage that includes a field-effect transistor.

The foregoing summary is intended merely to provide a brief description of the general nature of the invention. A more complete understanding of the invention can be obtained by referring to the claims and the following detailed description of the preferred embodiments in connection with the accompanying figures.

### BRIEF DESCRIPTION OF THE DRAWINGS

FIG. 1 is a front elevational view of a conventional ribbon microphone.

FIG. 2 is a front vertical cross-sectional schematic view of the transducer for a conventional ribbon microphone.

FIG. 3 is a front elevational view of a microphone according to the present invention.

FIG. 4 is a front vertical cross-sectional schematic view of a transducer according to the present invention.

FIG. 5 is a perspective view of the transducer shown in FIG. 4, with the magnetic housing omitted to show the interior structural details.

FIG. 6 is a bottom cross-sectional view of the transducer shown in FIG. 4.

FIG. 7 is a block diagram of the ribbon microphone circuitry according to a representative embodiment of the present invention.

FIG. 8 is a schematic diagram of the ribbon microphone circuitry according to a representative embodiment of the present invention.

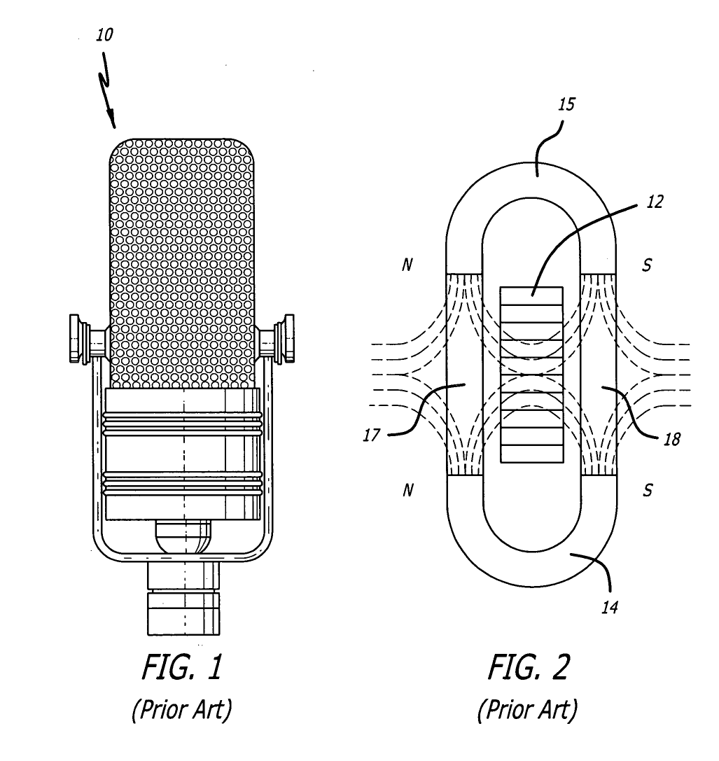

### DESCRIPTION OF THE PREFERRED EMBODIMENT(S)

The present disclosure covers inventions that are claimed herein and in the commonly assigned patent application filed concurrently herewith, titled “Ribbon-Microphone Transducer”, which application is incorporated by reference herein as though set forth herein in full.

The generating element of a conventional ribbon microphone produces a substantially weaker signal than that produced by a modern condenser microphone, and this signal often is considered inadequate to drive present-day preamplifiers, many of which having been designed for the higher output condenser microphones. Another issue is that conventional “passive” (unpowered) ribbon microphones are very sensitive to loading and require preamplifier input stages that possess higher input impedances than those of most contemporary preamplifier designs.

Loading occurs when the input impedance of the preamplifier is lower than what the microphone wants to “see,” resulting in diminished performance as a result of over-damping the ribbon element. The ribbon element, even if coupled through a matching transformer, becomes effectively shorted out, causing reduced output and poor frequency response in the extreme-low-frequency register. One aspect of the present invention is to provide a ribbon microphone design that solves the problems associated with earlier configurations, i.e. the low output (sensitivity) issue, the loading (impedance matching) issue and the physical bulk issue.

As described in more detail below, the ribbon microphone according to the present invention addresses the low-output issue, typically requiring much less gain to be provided by the microphone preamplifier. This can improve the signal-to-noise ratio, even with preamplifiers of mediocre noise performance, allow long cable runs and isolate the ribbon from electrical damage. By effectively isolating the ribbon element from the outside world, a design according to the present invention often can make it nearly impossible to damage the ribbon as a result inadvertent application of voltage to the microphone from faulty cabling or phantom-power-related problems.

One aspect of certain embodiments of the present invention is that the increased output capability of the microphone is not the result of traditional amplification methods in which a conventional electronic amplifying circuit (either with vacuum tubes or solid-state devices), would be used to directly “amplify” the output of the generating element (ribbon). Rather, these embodiments use a specially designed “stiff-turns-ratio” step-up transformer that has its output feeding an essentially infinite load and then this signal is electronically buffered to a produce a usable low-impedance output with drive capability. The specialized high-turns-ratio transformer alone is responsible for the voltage gain. It is the unique way that the output signal of this transformer is utilized, without any significant form of loading being placed upon it by the following stage, that makes the configuration practical. The active electronics package is not required to provide any additional gain (i.e., actual gain typically is less than unity), but rather serves as a means of isolation and impedance conversion.

The present invention also provides a unique ribbon transducer to provide the desired low-noise performance and extended high-frequency characteristics. The improved transducer typically can provide the necessary source voltage needed by the specialized step-up transformer, enabling it to operate at maximum efficiency and true linearity. Moreover, this transducer generally can be made as a very compact unit.

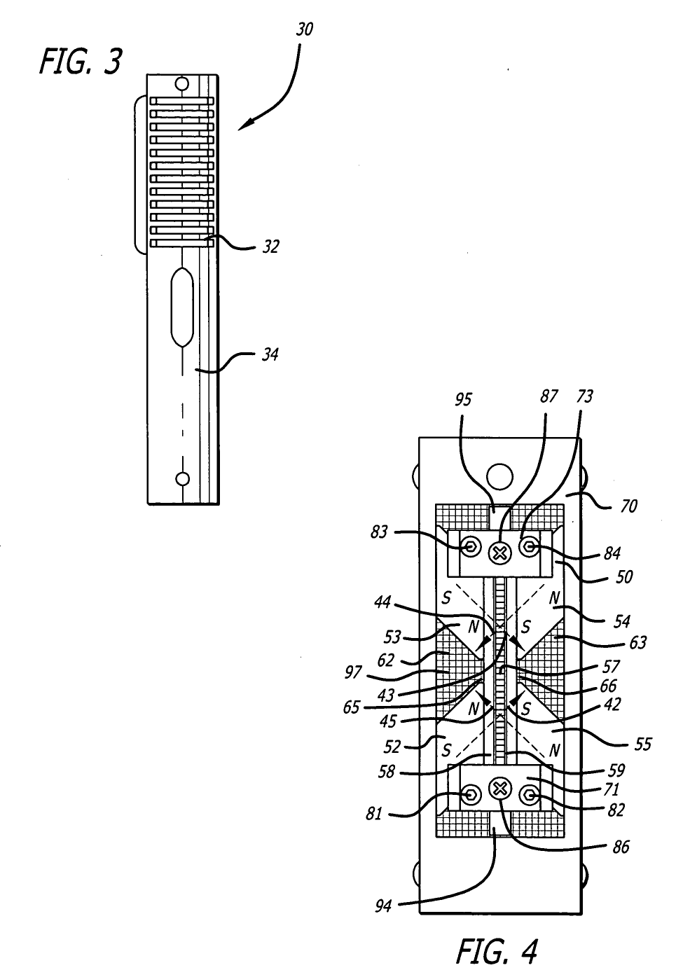

FIG. 3 is a front elevational view of a microphone 30 that has been manufactured according to the present invention. In contrast to the conventional ribbon microphone (whose weight and dimensions are given above), microphone 30 weighs only 8.6 ounces, and is approximately 6 inches long by 1 inch in diameter. Because microphone 30 is so compact, internal sound-wave reflections can be minimized, which is particularly important for good high-frequency response. The upper portion 32 of microphone 30 includes the microphone's transducer, while the lower portion 34 includes the transformer and other transducer-output circuitry.

The first section of the following disclosure focuses on the transducer for a ribbon microphone 30 according to the present invention. The following section focuses on the circuitry for processing the transducer's output.

Ribbon-Microphone Transducer.

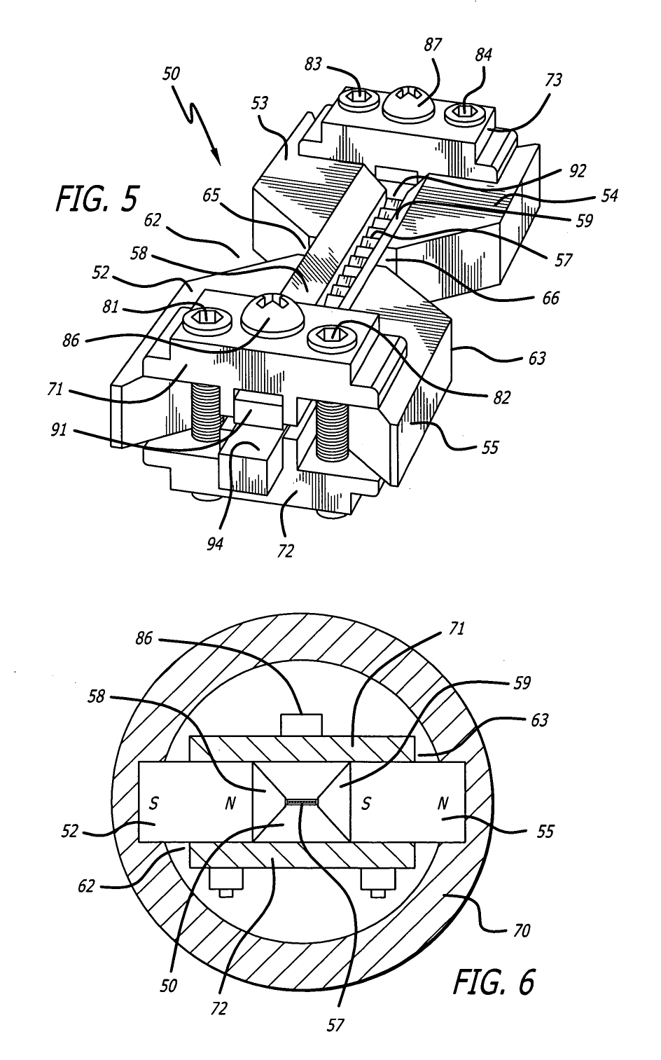

To obtain an adequate magnitude and appropriate orientation of magnetic flux, as well as to achieve the other design objectives of the present invention, including high output capability, superb high-frequency response, excellent transient-response characteristics, very compact size and very low magnetic leakage, the present invention utilizes a radically different approach to transducer design. FIGS. 4-6 illustrate the design of a transducer 50 according to the present invention.

Similar to conventional ribbon microphones, transducer 50 consists of a ribbon 57 suspended in an elongated gap between two sides 62 and 63 of a magnet structure. One of the sides 62 provides an overall magnetic north pole adjacent ribbon 57 and the other side 63 provides an overall magnetic south pole adjacent ribbon 57.

However, unlike conventional designs, magnetic poles 4245 (provided by corresponding magnets 52-55) are angled relative to ribbon 57. As noted above, most conventional ribbon microphones 10 have magnetic poles that are parallel to the ribbon element. As a result, the magnetic flux, at least in the first instance, is parallel to the ribbon element. Of course, even in such conventional designs, the magnet structure causes the lines of flux to bend, meaning that at certain points the flux is angled or even perpendicular to the ribbon element. However, such designs are far from the present inventors' goal of maximizing the amount of magnetic flux that is perpendicular to the ribbon element 57.

The transducer design described in the '252 patent addressed this design goal by providing a magnet structure in which the magnetic poles are completely perpendicular to the ribbon element. On the other hand, the present invention, while recognizing the desirability of utilizing perfectly perpendicular magnetic poles, provides an improved design in which perpendicular or near-perpendicular magnetic flux can be achieved while simultaneously providing other advantages that improve the performance of the ribbon microphone 30.

Specifically, the present inventors have discovered that by angling the magnetic poles, or their corresponding magnets, relative to the ribbon element 57, flux characteristics similar to those obtained by using perpendicular magnetic poles often can be achieved. At the same time, for example, in appropriately designed embodiments of the present invention, the front-to-rear distance around the ribbon 57, which is an important factor in determining high-frequency response, can be significantly reduced.

These advantages can be observed with reference to the specific embodiment illustrated in FIGS. 4-6. In this embodiment, each of magnets 52-55 is a distinct bar-shaped magnet in the specific shape of a parallelogram, and is angled relative to ribbon 57 at an angle of approximately 45 degrees. One result of this configuration is a tapering of magnets 52-55 toward (or, correspondingly, a widening away from) the center of ribbon 57. Such a feature is further emphasized by providing a gap 65 between the magnets 52 and 53 on side 62 and a corresponding gap 66 between the magnets 54 and 55 on side 63. The combination of these features provides an interval 65, 66 along the length of ribbon 57 where the front-to-rear distance around ribbon 57 is defined only by the ribbon 57 itself and pole pieces 58 and 59, followed by a smooth increase in the front-to-rear distance based on the taper angle of magnets 52-55. The net result of such features is a reduction in the overall effective front-to-rear distance around ribbon 57.

Moreover, the angling of magnets 52-55 (or, more appropriately, all relevant magnetic poles) toward the center of ribbon 57, particularly in the cross-field configuration illustrated) can provide adequate magnetic flux at the center of ribbon 57, even where a gap 65, 66 is utilized. For example, in the illustrated embodiment flux can flow from pole 44 to pole 42 through the center of ribbon 57 and, similarly, flux can flow from pole 45 to pole 43 through the center of ribbon 57.

Magnetic north poles 42 and 43 and magnetic south poles 44 and 45 are provided by incorporating four very powerful (grade 46) Neodymium magnets 52-55, respectively, arranged in such a fashion that the flux path is more perpendicular to the ribbon element than in the common conventional design described above, and a significant amount of the magnetic energy is focused toward the center of ribbon 57, thereby improving both sensitivity and efficiency. In the preferred embodiments, the four Neodymium magnets are parallelogram in shape and are bonded directly to a pair of tapered pole pieces 58 and 59 that preferably are machined from solid Permendur or Hyperco 90 alloy. These alloys are chosen for their high magnetic permeability and transfer greater flux than iron. In the preferred embodiment of the invention, pole pieces 58 and 59 are approximately 1.2 inches long and 0.075 inch wide, tapering from a thickness of 0.230 inch where they are attached to magnets 52-55 to a thickness of 0.060 inch where they are immediately adjacent to ribbon 57.

In the present embodiment of the invention, complementary magnetic sub-structures, each consisting of two pairs of magnets (52 and 53 on side 62 and 54 and 55 on side 63) and a pole piece (58 or 59, respectively), are arranged in an opposing fashion to form the basis of the magnet structure. The arrangement of the structures, when assembled, takes on the form of an “X” and, similarly, some of the lines of flux assume this same characteristic shape. An outer magnetically permeable housing 70, shown in FIGS. 3 (i.e., essentially the entire visible portion of microphone 30 in FIG. 3), 4 and 6, preferably is made of ingot-iron and serves to complete the closed magnetic circuit of each half of the magnet sub-structures (i.e., the magnets and their corresponding pole piece). As shown in FIG. 3, housing 70 provided with a plurality of horizontal slits for allowing sound waves to enter it. Although only shown on the front surface of microphone 30, similar slits preferably are provided on the rear surface as well.

As noted above, one side 62 provides a magnetic north field and, conversely, the other side 63 provides a magnetic south field, with the lines of flux converging and concentrating a significant amount of their energy at the center of the transducer 50, where the ribbon 57 sits in an air gap between the magnet/pole-piece assemblies. This arrangement may be referred to as a “cross-field transducer”, as the magnet structure and resulting flux paths form a cross through the center of the ribbon 57.

The two opposing magnetic sub-structures are held apart from each other, forming an air-gap, preferably at a precise distance of 0.0700 inch. This is accomplished with a pair of precisely machined clamping assemblies, which also serve to position and tension the ribbon element. The bottom clamping assembly includes an upper clamp 71 and a lower clamp 72 held together by clamping screws 81 and 82, and the top clamping assembly includes an upper clamp 73 and a lower clamp 74 held together by clamping screws 83 and 84. Brass preferably is used for the clamps 71-74 because of its strength and non-ferrous nature, because a ferrous material would disrupt the directional flow of the magnetic flux energy. Ribbon tensioning screws 86 and 87 are used to control the amount of tension in ribbon 57, calibrated pole-piece spacers 91 and 92 are included, and solder pads 94 and 95 are used as electrical contacts for the signal output by ribbon 57. Similar to conventional ribbon microphones, front and rear dampening screens preferably are used, although only the rear dampening screen 97 is shown in the drawings (i.e., in FIG. 4).

The foregoing transducer assembly is fitted into a channeled, cylindrically shaped, ingot iron or low-carbon steel housing 70, which serves to provide the magnetic return circuit for the complementary paired transducer assembly components, while simultaneously minimizing stray radiated magnetism and shielding the transducer from external electromagnetic radiation. The housing 70 also functions as an acoustic baffle chamber for the ribbon element 57. This unique approach to transducer design can offer greatly improved performance in a very compact package. Very little magnetic energy escapes such a structure, and externally radiated magnetic fields have minimal effect on the transducer's performance. Unwanted hum and noise often can be reduced significantly by such a configuration. As noted above, the entire assembly, with all of its components, sometimes is referred to as a “cross-field transducer”.

For greatest sensitivity, the ribbon element 57 preferably is constructed of pure (99.99%) aluminum. Aluminum is chosen for its low mass and excellent electrical properties. The ribbon is corrugated to provide strength, elasticity and durability.

The ribbon 57 used for the transducer of a ribbon microphone 50 according to the present invention preferably is very small, e.g., measuring only 0.0625 inch in width and 1.2 inches in length. The thickness of the ribbon 57 preferably is 1.8-microns, and the ribbon 57 weighs less than ⅓ of a milligram. The ribbon's small dimensions and the thinness of its material contribute much to its superb frequency response and transient response characteristics. Accordingly, in any event ribbon 57 preferably is less than 2 inches long, ¼inch wide and 2 microns thick. It is suspended within the air gap of the “cross-field” transducer at a tension that is determined electronically by measuring the impedance rise at resonance. The preferred resonance frequency of this transducer is between 70-90 Hz.

Ribbon 57 preferably is suspended between pole pieces 58 and 59 at a distance of 0.002-0.003 inch on each side. The length of the transducer 50 from the bottom of magnets 52 and 55 to the top of magnets 53 and 54 is approximately 1.9 inches. The width of transducer 50 from the outer edge of magnets 52 and 53 to the outer edge of magnets 54 and 55 is approximately 0.8 inch. Housing 70 preferably is less than 1 inch or less in diameter and 2.5 inches long. In the current embodiment of the invention, housing 70 also serves as the outer housing of microphone 30. Accordingly, in FIG. 3 housing 70 essentially is the only part of microphone 30 that is visible. However, in other embodiments a separate outer housing that encloses magnetically permeable housing 70 may be utilized and/or housing 70 may simply be painted, plated or otherwise coated to provide and aesthetically pleasing outer surface.

Magnets 52-55 preferably are approximately ¼ inch thick, and magnets 52-55 (and/or their corresponding magnetic poles 4245) preferably are angled relative to ribbon 57 at an angle of 10-80 degrees, with 0 degrees corresponding to a parallel orientation and 90 degrees corresponding to a perpendicular orientation. As noted above, more preferably magnets 52-55 (and/or their corresponding magnetic poles 42-45) are angled relative to ribbon 57 at an angle of approximately 45 degrees. In any event, magnets 52-55 preferably are angled so as to taper away from the center of ribbon 57, e.g., in the cross-field configuration discussed above and illustrated in the drawings.

However, it should be noted that other configurations in accordance with the foregoing teachings instead may be used. Also, while magnets 52-55 in the above-described embodiment are distinct straight bar magnets, magnetic poles 42-45 instead may be provided using magnets having other configurations and/or using fewer magnets (e.g., with poles 42 and 45 being provided by one magnet and poles 43 and 44 being provided by another).

As noted above, one of the advantages of the present configuration is a significantly reduced front-to-rear distance around ribbon 57, which is provided to the use of the magnet structure described above, including the provision of a gap 65, 66 and/or tapered magnets 52-55, together with strong permanent magnets that need not be as wide as magnets previously used in ribbon microphones. For example, a ribbon microphone 30 having the configuration and dimensions indicated above can have an overall effective front-to-rear distance of 5/16-⅜ inch. This is significantly less than the front-to-rear distance for conventional ribbon microphones.

Ribbon-Microphone Circuitry.

A ribbon element transducer alone typically is unable to provide a usable signal for most purposes. The impedance of the ribbon element 12 or 57 is extremely low (usually less than 1 Ohm (Ω)), and the electrical signal is very weak, typically necessitating the need for a transformer to convert the impedance to something more usable and to provide a certain amount of voltage gain. In most conventional ribbon microphones 10, the output of the transformer is fed directly to the input of a microphone preamplifier, a separate device that is designed to boost the microphone's signal to a usable level. The input impedance of the external preamplifier often will determine the overall performance of the microphone. With this being the case, selection of a suitable microphone preamplifier becomes paramount for correctly mating any conventional passive ribbon microphone to a gain stage.

The specific impedance of the ribbon 12 or 57 is determined by four factors: the ribbon's length, width, thickness, and material composition. Conventionally, the duty of the transformer is to “match” this impedance to that which is suitable for use with a microphone preamplifier. More precisely, the impedance of a specific ribbon transducer will be a specific value, say, 0.5 Ohm, and the turns-ratio of the transformer would be chosen to give an output impedance of 200-300Ω, because modern preamplifiers generally are designed to be fed from source impedances in this range. Manipulating the transformer's turns ratio in an attempt to maximize the output voltage from the microphone generally is unsatisfactory on its own, because the impedance of the microphone would be considerably higher than would be acceptable for direct connection to a typical preamplifier. Furthermore, with many transformer winding methods, the very stiff ratios needed for this purpose could not be attained without substantial limitations in the frequency response.

Previous designers developed experimental buffering stages in an attempt to exploit the virtues of higher-turns-ratio transformers, but the performance of these experimental circuits was restricted by the limited sensitivity of the transducer, limitations of the transformers that they were using, and excessive noise from the transistors that they employed. Accordingly, the experiments were never developed into commercially successful products. Furthermore, these experimental microphones often required dedicated power supplies or batteries. The use of “phantom power” (voltage being supplied to a microphone through the microphone cable) in a ribbon microphone is not believed to have ever been attempted.

One of the innovations in ribbon-microphone development according to the present invention is the use of a different class of transformers than previously has been employed in this context. The present invention preferably uses a transformer that provides very stiff turns ratios in the range of 1:100-1:200 (primary:secondary) but without the frequency-limiting characteristics of transformer designs previously used for ribbon microphones. The turns ratio preferably is chosen to produce a predetermined open-circuit sensitivity, e.g., 10 mV per Pascal (pa) ( or −40 dBv re. 1 v/pa), so that the microphone output would be comparable to a modern capacitor microphone.

In addition, a ribbon-microphone transformer according to the present invention preferably incorporates the following design parameters:

a) The DC resistance of the primary winding preferably is kept to a figure of less than 0.06Ω, in order to avoid making a voltage divider of the ribbon and transformer primary.

b) The inductance of the primary winding preferably is not allowed to be below a value that is related to (e.g., equal to or at least on the same order as) the A.C. impedance curve of the ribbon assembly, unless a deliberate bass roll-off is desired.

c) Leakage inductance preferably is kept to a minimum.

d) Stray capacitance preferably is kept to a minimum.

To accomplish these goals, a ribbon microphone according to the present invention preferably uses a transformer having a toroidal configuration with a special core and multiple interleaved primary windings. More preferably, the primary windings are interleaved with the secondary windings to maximize transformer efficiency and to maintain flat linear response, especially in the low-frequency range (below 100 HZ). The core of the transformer is of a “tape wound” configuration, instead of being a ferrite or compressed composite material. The “tape wound” core is constructed from thin M-6 (nickel iron) core material that is cut into a strip of an appropriate length/width and rolled up very tightly in the shape of a short ring or doughnut.

The windings of the transformer are tightly wound through and around this doughnut-shaped core. The windings themselves are tailored to the function and purpose of this transformer.

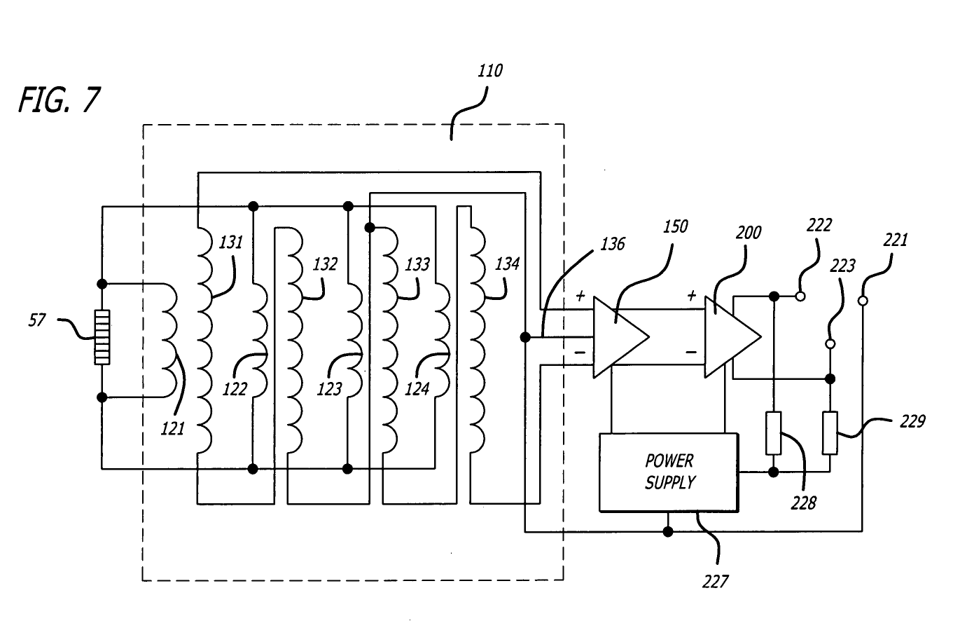

A schematic diagram of the configuration of transformer 110, according to the preferred embodiment of the invention, is illustrated in FIG. 7. Four independent parallel-connected primary windings 121-124 are interleaved with multiple (preferably four) serially connected secondary windings 131-134, with the secondary windings collectively being center-tapped 136. The primary windings 121-124 preferably are connected in parallel to provide the correct impedance match to the ribbon element 57. This arrangement allows the transformer 110 to have the desired voltage-gain characteristics, while maintaining excellent frequency response.

When the transformer primary 121-124 is connected to the ribbon 57 a closed-loop system is created, assuming that the transformer 110 has no load imposed on the secondary windings 131-134. This is a preferred condition for the “active ribbon” microphone 30 according to the present invention to work appropriately. With a closed-loop condition, the ribbon dampening remains fixed and is unaffected by external conditions such as preamplifier impedance, cable capacitance and other influences.

However, in order for this to function as a true closed-loop system, the secondary of the transformer 110 must always “see” a very high impedance load that is fixed in value. When these conditions are satisfactorily met, the transformer 110 alone can provide all the voltage gain necessary for operation.

Accordingly, a buffer stage 150 of extremely high input impedance (e.g., a minimum of 10 Megohms), very-low input capacitance and extremely low noise preferably is used in ribbon microphone 30 according to the present invention. A more conventional circuit typically would be susceptible to input overload unless some form of “electronic padding” was provided to minimize this condition, which then would compromise the performance of the microphone.

More specifically, the preferred buffer/converter stage 150 is designed to provide a very high source impedance to the transformer 110 and a low-impedance output signal capable of driving any standard conventional microphone preamplifier. The active stage in the present embodiment has a true gain of less than unity, e.g., not greater than 0.81, and therefore contributes no voltage amplification whatsoever. It serves only to provide impedance conversion and low-impedance buffering. This circuit arrangement, with a gain of less than unity, particularly in combination with the other features described herein, often can enable the microphone 30 to deliver very low noise and low distortion without any possibility of overload.

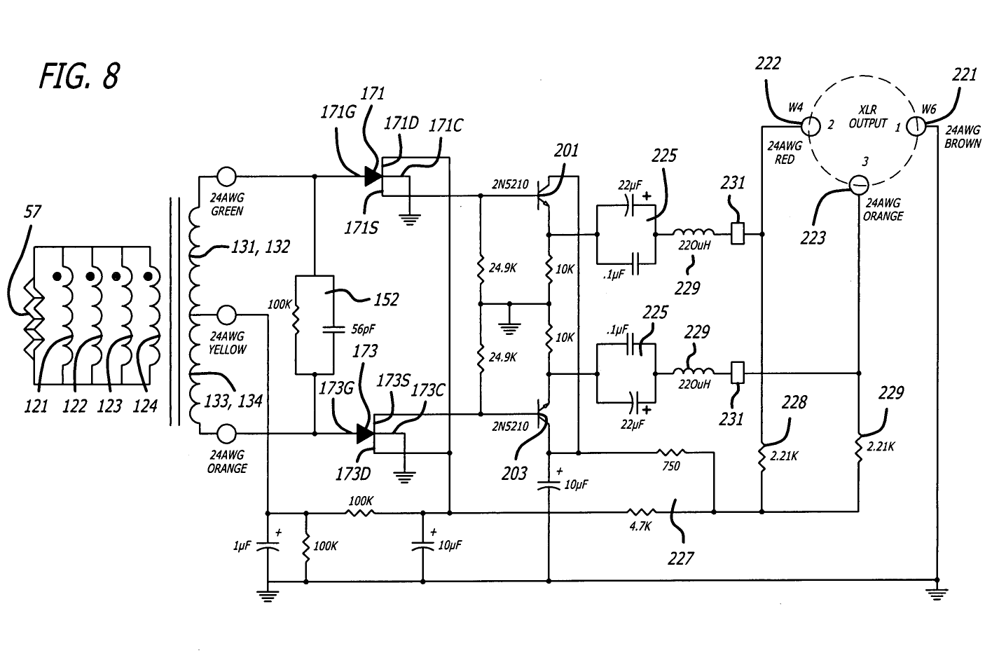

A specific circuit for achieving the foregoing goals, which implements the block diagram shown in FIG. 7, is shown in FIG. 8. Unless otherwise specified in FIG. 8, all resistor values are in ohms (Ω) with a 1% tolerance, all capacitor values are in Microfarads (μF), and all inductor values are in Microhenries (μH).

Referring to FIGS. 7 and 8, the transformer 110 is electrically compensated (using resistor/capacitor network 152) for flat response and then fed to ultra-high-impedance balanced buffer 150, which includes FETs 171 and 173, with the center tap 136 of the transformer secondary 131-134 being a zero-signal reference. As shown, the “upper” 131, 132 and “lower” 133, 134 sections of the secondary windings feed identical (differential) halves of the balanced buffer 150.

Thus, the first half of the circuit shown in FIGS. 7 and 8 is the input buffer 150, comprised of two low-noise, large-die field-effect transistors (FETs) 171 and 173 having corresponding gate 171G and 173G, source 171S and 173S, drain 171D and 173D and case 171C and 173C terminals. Its job is to effectively and completely isolate the output (secondary windings) of the ribbon impedance-matching transformer 110 from any form of load. The input buffer 150 matches the high impedance output of the transformer 110 and provides a lower impedance source signal that is coupled directly to the differential bipolar output stage 200.

The thermal (or shot) noise of the input devices (i.e., the FETs 171 and 173) preferably is extremely low because the source signal voltage generally will be very low, and any noise contributed by such input devices gets passed along to the output of microphone 30. To keep the noise level at a minimum, specially designed large-die N-channel silicon junction field-effect transistors 171 and 173 preferably are used. The equivalent short-circuit input noise of these devices preferably is 0.3 nV/√Hz @ 100 Hz. A balanced FET arrangement preferably is used for the first stage 150. The two FET devices 171 and 173 are fed signals that are 180° out of phase with each other. This push-pull arrangement is referenced to the transformer's center tap 136. Bias for both devices 171 and 173 is applied at the transformer's center tap 136.

It should be noted that FETs are preferred not only because they have high input impedances. There are bipolar devices that would serve adequately for this application and with better noise-performance specifications. Rather, FETs are preferred for the first active stage 150 primarily because FETs are not prone to forward-bias issues that would allow voltage spikes to momentarily appear at the transformer's secondary windings 131-134 when the microphone 30 is plugged into a cable or activated with phantom power. Many bipolar devices would allow voltage spikes to reach the ribbon 57, causing the ribbon 57 to deflect and possibly become damaged.

Each FET 171 and 173 in the buffer stage 150 is susceptible to loading due to its relatively high-impedance characteristics at its outputs, and because it does not have sufficient drive current to serve as the sole drive source of the microphone on its own. As a result, the FETs 171 and 173 preferably are coupled to a balanced emitter follower stage 200, which preferably utilizes two 2N5210 NPN transistors 201 and 203. This configuration serves to further isolate the FETs 171 and 173 and transformer 110 and provides the actual output drive of the microphone 30. It is noted that no global feedback loop network is employed in the active circuitry.

The present invention's circuitry preferably is conveniently powered through the microphone cable via a technique (which is an industry standard for certain other types of microphones) known as “phantom” power. Phantom power provides 48 Volts of DC power along the balanced signal conductors of a three conductor microphone cable. Pin 221 serves as a ground reference, and pins 222 and 223 form a differential signal path. The 48-Volt phantom supply is placed midpoint between pin 222 and pin 223, with pin 221 serving as the minus leg. Up to 10 milliamps of total supply current is available through this system. The phantom supply voltage is provided directly to the microphone 30 through the cable, from a microphone preamplifier that has phantom capability. The microphone's power-supply electronics 227 (which may be deemed to include resistors 228 and 229) tap this supply voltage, filter it and provide the correct voltages to the FETs 171, 173 and the transistors 201, 203. Blocking capacitors 225 prevent DC voltages from backing into the signal path. The microphone's audio signal is also carried along this differential pair, with pin 222 carrying the in-phase signal and pin 223 carrying the out-of-phase signal.

As shown, inductors 229 are provided for filtering out any radio-frequency signals that might otherwise be introduced into the circuitry from the microphone cable. For similar reasons, the wires connecting the electronics to pins 222 and 223 are wrapped around ferrite beads 231, thereby creating an additional inductance which further helps to suppress radio-frequency signals.

In the above embodiment of the invention, a single transducer 50 is provided within microphone 30. However, in alternate embodiments multiple transducers may be included within the same housing. In such a configuration, it is preferable to use two transducers, with one above the other and the front of one being offset approximately 90 degrees from the front of the other around the microphone's housing, thereby providing a stereo microphone.

Additional Considerations.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality may be ascribed to a particular module or component. However, unless any particular functionality is described above as being critical to the referenced module or component, functionality may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. A ribbon-microphone circuit, comprising:
(a) a magnet structure forming an elongated central gap such that an overall magnetic north pole is provided on a first side of the elongated central gap and an overall magnetic south pole is provided on a second side of the elongated central gap;
(b) a thin strip of electrically conductive material, referred to as a ribbon, suspended within the elongated central gap;
(c) an electrical contact at each end of the ribbon for outputting a signal generated by the ribbon; and
(d) a step-up toroidal transformer, having plural primary coils electrically coupled to the electrical contacts of the ribbon and having at least one secondary coil.

2. A ribbon-microphone circuit according to claim 1, wherein the step-up toroidal transformer has exactly four primary coils.

3. A ribbon-microphone circuit according to claim 1, wherein the step-up toroidal transformer is a tape-wound-core transformer.

4. A ribbon-microphone circuit according to claim 1, wherein the turns ratio of the at least one secondary coil to the plural primary coils is at least 100:1.

5. A ribbon-microphone circuit according to claim 1, wherein the turns ratio of the at least one secondary coil to the plural primary coils is at least 200:1.

6. A ribbon-microphone circuit according to claim 1, wherein the plural primary coils are interleaved.

7. A ribbon-microphone circuit according to claim 1, further comprising an outer casing having a circumference of no more than 6 inches that encloses the magnet structure, the ribbon and the step-up toroidal transformer.

8. A ribbon-microphone circuit according to claim 7, further comprising a buffer circuit that is also enclosed within the outer casing and is electrically coupled to the at least one secondary coil.

9. A ribbon-microphone circuit according to claim 8, wherein the buffer circuit has an input impedance of at least 10 Megohms.

10. A ribbon-microphone circuit according to claim 1, wherein the step-up toroidal transformer includes at least three interleaved secondary coils.

11. A ribbon-microphone circuit according to claim 10, wherein the step-up transformer includes at least three interleaved primary coils.

12. A ribbon-microphone circuit according to claim 1, wherein the step-up transformer includes at least three interleaved primary coils.

13. A ribbon-microphone circuit, comprising:
(a) a magnet structure forming an elongated central gap such that an overall magnetic north pole is provided on a first side of the elongated central gap and an overall magnetic south pole is provided on a second side of the elongated central gap;
(b) a thin strip of electrically conductive material, referred to as a ribbon, suspended within the elongated central gap;
(c) an electrical contact at each end of the ribbon for outputting a signal generated by the ribbon; and
(d) a step-up transformer, having plural interleaved primary coils electrically coupled to the electrical contacts of the ribbon and having at least one secondary coil.

14. A ribbon-microphone circuit according to claim 13, wherein the step-up transformer is a toroidal transformer.

15. A ribbon-microphone circuit according to claim 13, wherein the turns ratio of the at least one secondary coil to the plural primary coils is at least 60:1.

16. A ribbon-microphone circuit according to claim 13, wherein the turns ratio of the at least one secondary coil to the plural primary coils is at least 100:1.

17. A ribbon-microphone circuit according to claim 13, wherein the turns ratio of the at least one secondary coil to the at least one primary coil is at least 200:1.

18. A ribbon-microphone circuit according to claim 13, further comprising an outer casing having a circumference of no more than 6 inches that encloses the magnet structure, the ribbon and the step-up transformer.

19. A ribbon-microphone circuit according to claim 18, further comprising a buffer circuit that is also enclosed within the outer casing and is electrically coupled to the at least one secondary coil.

20. A ribbon-microphone circuit according to claim 19, wherein the buffer circuit has an input impedance of at least 10 megohms.

21. A ribbon-microphone circuit according to claim 19, wherein the buffer circuit has an input stage that comprises a field-effect transistor.

22. A ribbon-microphone circuit according to claim 13, wherein the step-up transformer includes at least three interleaved secondary coils.

23. A ribbon-microphone circuit according to claim 22, wherein the step-up transformer includes at least three interleaved primary coils.

24. A ribbon-microphone circuit according to claim 13, wherein the step-up transformer includes at least three interleaved primary coils.

25. A ribbon-microphone circuit according to claim 13, wherein the step-up transformer includes has exactly four interleaved primary coils.
